(19) United States
(12) Patent Application Publication
(10) Pub. No.: US 2013/0233466 A1
(43) Pub. Date: Sep. 12, 2013

(54) METHOD AND DEVICE FOR INJECTING LIQUID CRYSTAL OF FILM SUBSTRATE

(71) Applicant: FUJITSU FRONTECH LIMITED, Tokyo (JP)

(72) Inventors: Kazuya OHHASHI, Tokyo (JP); Hidenobu HAMADA, Tokyo (JP)

(73) Assignee: Fujitsu Frontech Limited, Tokyo (JP)

(21) Appl. No.: 13/870,444

(22) Filed: Apr. 25, 2013

Related U.S. Application Data
(63) Continuation of application No. PCT/JP2010/073463, filed on Dec. 24, 2010.

(51) Int. Cl. B32B 37/14

(52) U.S. Cl. CPC B32B 37/14
USPC 156/145; 156/538; 239/302

(57) ABSTRACT

A method for injecting a liquid crystal material into a film substrate includes: a contacting step of forming a gap between a liquid crystal inlet of the film substrate and a bottom of a liquid crystal vessel which stores the liquid crystal material by making the film substrate contact a contact part provided for the liquid crystal vessel; and an injecting step of injecting the liquid crystal material into the liquid crystal inlet with the film substrate contacting the contact part.

### CROSS-REFERENCE TO RELATED APPLICATIONS

This application is a continuation application of International Application PCT/JP2010/073463 filed on Dec. 24, 2010 and designated the U.S., the entire contents of which are incorporated herein by reference.

### FIELD OF THE INVENTION

The embodiment described in the present specification is related to a method and a device for injecting a liquid crystal of a film substrate.

### BACKGROUND OF THE INVENTION

Conventionally, there has been a liquid crystal panel which is designed so that the electrode of the transparent substrate provided with a transparent electrode is bonded with and faces the electrode of another substrate, a liquid crystal material is sealed between the transparent substrates, and a voltage is applied between the electrodes, thereby allowing the liquid crystal material to cause a reaction for display.

A method for injecting a liquid crystal material into a liquid crystal panel may be a method of injecting a liquid crystal material from an aperture provided in the sealing frame unit for bonding a first substrate and a second substrate.

This injecting method is briefly described below with reference to FIGS. 6A through 6C and 7A through 7I.

As illustrated in FIGS. 6A through 6C, a first substrate 110 and a second substrate 120 each of which is formed by a transparent film is bonded by a rectangular sealing frame unit 130. An aperture 131 for injection of a liquid crystal material is formed in one of the four sides of the sealing frame unit 130. The sealing frame unit 130 seals the liquid crystal material described later between the first substrate 110 and the second substrate 120.

As illustrated in FIG. 7A, the first substrate 110 and the second substrate 120 bonded by the sealing frame unit 130 are stored in a housing not illustrated in the attached drawings, and decompressed (placed in a decompressed state) until, for example, the inside of the housing is placed in a vacuum.

Then, as illustrated in FIG. 7B, with the first substrate 110 and the second substrate 120 placed in a vacuum, the sides of the apertures 131 illustrated in FIGS. 6A and 6B of the sealing frame units 130 are soaked in a liquid crystal material 140 in a liquid crystal vessel 170.

As illustrated in FIGS. 7C and 7D, when the decompressed state in the housing not illustrated in the attached drawings is released and replaced with a normal pressure state, an outside air pressure P is applied to the liquid crystal material 140, and the liquid crystal material 140 is filled in the sealing frame unit 130. Then, as illustrated in FIG. 7E, the first substrate 110 and the second substrate 120 are taken out of the liquid crystal material 140 in the liquid crystal vessel 170.

Then, as illustrated in FIG. 7F, the sides of the apertures 131 of the sealing frame units 130 (FIGS. 6A and 6B) of the first substrate 110 and the second substrate 120 are soaked in a sealing material 151 in a sealing material vessel 180.

Then, as illustrated in FIG. 7G, when the first substrate 110 and the second substrate 120 are taken out of the sealing material 151 in the sealing material vessel 180, the sealing material 151 adheres to the first substrate 110 and the second substrate 120.

Next, as illustrated in FIG. 7H, using ultraviolet rays UV, the ultraviolet irradiation unit 160 cures the adhered sealing material 151 (curable sealing material 152) . Then, as illustrated in FIG. 7I, a part 152′ of the curable sealing material 152 is removed along the surfaces of the first substrate 110 and the second substrate 120.

When the liquid crystal material is injected, a jig having the concave part for containing the amount of the injected liquid crystal material is made to closely contact the liquid crystal inlet by moving the jig upward to the outside of the liquid crystal material, thereby injecting the liquid crystal material (for example, patent document 1).

In addition, when the liquid crystal material is injected, it may be injected from the liquid crystal suction holder to the liquid crystal inlet with the liquid crystal suction holder, which is soaked in the liquid crystal material, held by a support member (for example, patent document 2).

Furthermore, when the liquid crystal material is injected, it may be injected from the liquid crystal material to the liquid crystal inlet with the liquid crystal suction holder, which is soaked in the liquid crystal material, positioned by a positioning member (for example, patent document 3).

Patent Document 1: Japanese Laid-open Patent Publication No. 2004-341236

Patent Document 2: Japanese Laid-open Patent Publication No. 2005-181601

Patent Document 3: Japanese Laid-open Patent Publication No. 2005-345500

### SUMMARY OF THE INVENTION

The method for injecting a liquid crystal material into a film substrate disclosed by the present specification includes: a contacting step of forming a gap between a liquid crystal inlet of the film substrate and a bottom of a liquid crystal vessel which stores the liquid crystal material by making the film substrate contact a contact part provided for the liquid crystal vessel; and an injecting step of injecting the liquid crystal material into the liquid crystal inlet with the film substrate contacting the contact part.

The liquid crystal injection device which injects a liquid crystal material into a film substrate disclosed by the present specification includes a liquid crystal vessel which stores the liquid crystal material, and the liquid crystal vessel includes a contact part which forms a gap between a liquid crystal inlet of the film substrate and a bottom of the liquid crystal vessel by making the liquid crystal vessel contact the film substrate.

### BRIEF DESCRIPTION OF DRAWINGS

FIG. 1A is a partial sectional view (1) of the liquid crystal injection device according to an embodiment of the present invention;

FIG. 1B is a partial sectional view (2) of the liquid crystal injection device according to an embodiment of the present invention;

FIG. 2A is a sectional view (1) along A-A in FIG. 1B;

FIG. 2B is a sectional view (2) along A-A in FIG. 1B;

FIG. 3A is a partial sectional view (1) of the liquid crystal injection device according to another embodiment of the present invention;

FIG. 3B is a partial sectional view (2) of the liquid crystal injection device according to another embodiment of the present invention;

FIG. 4 is an enlarged view of the part B in FIG. 3B;

FIG. 5 is a sectional view of the groove having a U-shaped section according to a variation example according to another embodiment;

FIG. 6A is an exploded view of the film substrate for explanation of the control liquid crystal injecting method;

FIG. 6B is a plan view of the film substrate for explanation of the control liquid crystal injecting method;

FIG. 6C is a sectional view along C-C in FIG. 6B;

FIG. 7A is a sectional view (1) for explanation of the conventional liquid crystal injecting method;

FIG. 7B is a sectional view (2) for explanation of the conventional liquid crystal injecting method;

FIG. 7C is a sectional view (3) for explanation of the conventional liquid crystal injecting method;

FIG. 7D is a sectional view (4) for explanation of the conventional liquid crystal injecting method;

FIG. 7E is a sectional view (5) for explanation of the conventional liquid crystal injecting method;

FIG. 7F is a sectional view (6) for explanation of the conventional liquid crystal injecting method;

FIG. 7G is a sectional view (7) for explanation of the conventional liquid crystal injecting method;

FIG. 7H is a sectional view (8) for explanation of the conventional liquid crystal injecting method;

FIG. 7I is a sectional view (9) for explanation of the conventional liquid crystal injecting method;

FIG. 8 is an explanatory view (1) for explanation of the usage of a liquid crystal material; and

FIG. 9 is an explanatory view (2) for explanation of the usage of a liquid crystal material.

### DESCRIPTION OF EMBODIMENTS

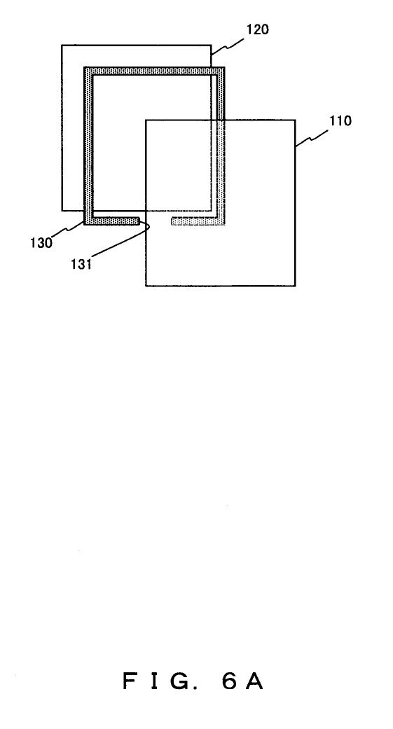

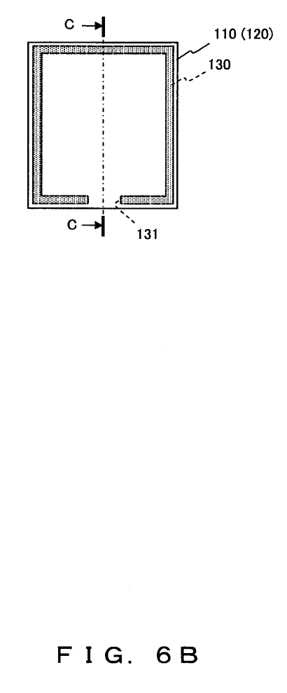

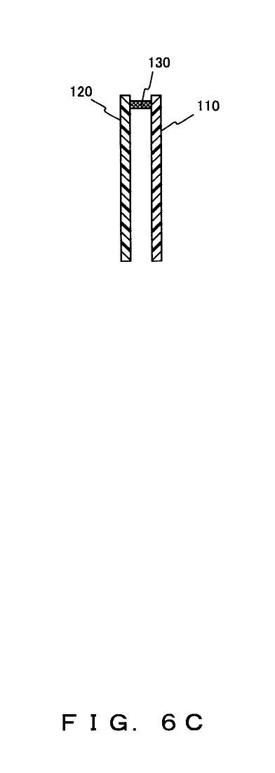

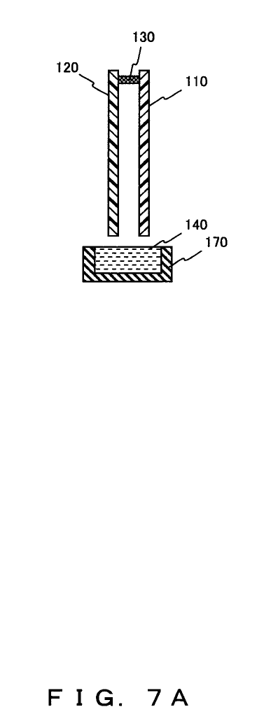

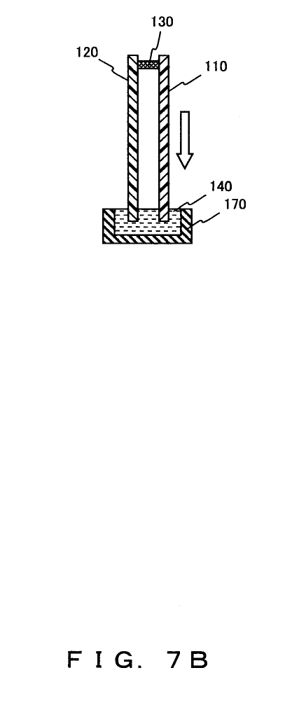

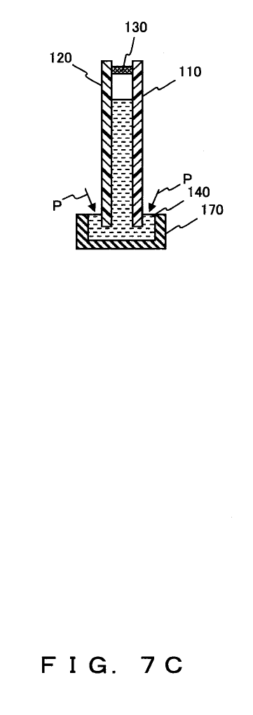

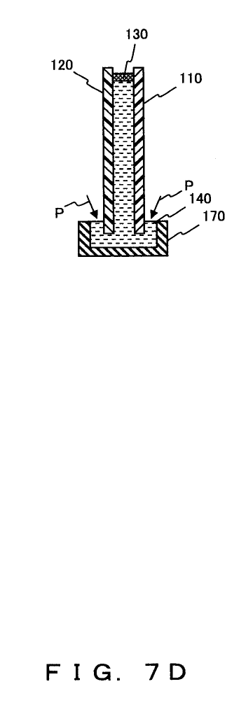

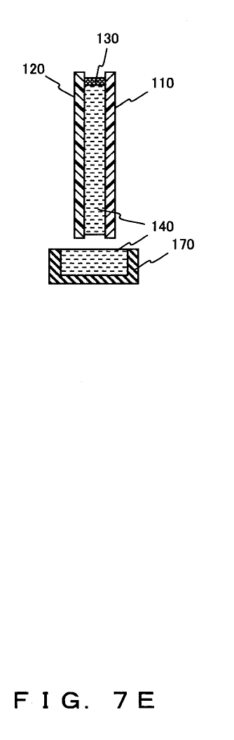

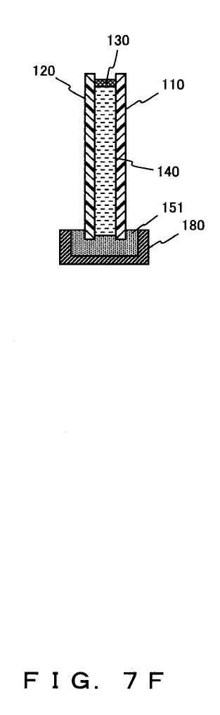

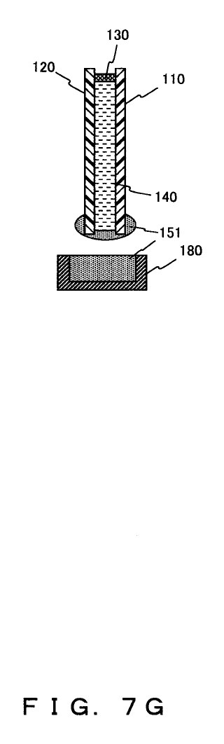

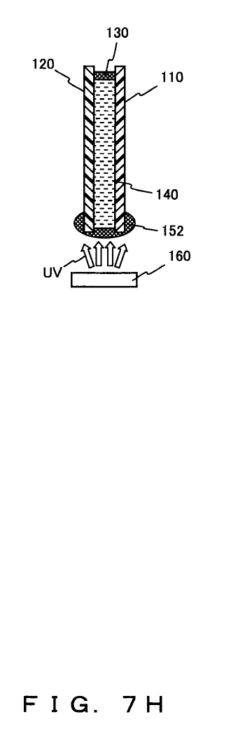

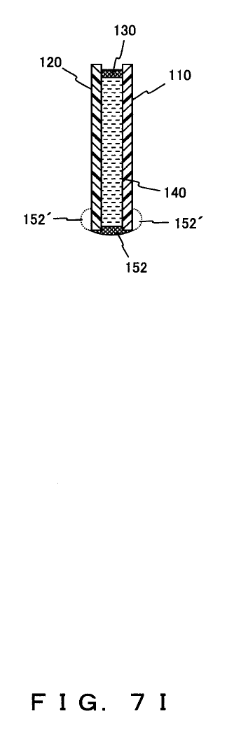

In the method of injecting a liquid crystal material as explained above with reference to FIGS. 6A through 6C and 7A through 7I, when the liquid crystal material 140 is insufficient when the lima is injected from the aperture 131, air or a gas enters the sealing frame unit 130, and the unit is not filled with the liquid crystal material 140. Therefore, the quantity of the liquid crystal material 140 larger than the necessary quantity of the liquid crystal material 140 to be injected into the sealing frame unit 130 is to be stored in the liquid crystal vessel 170.

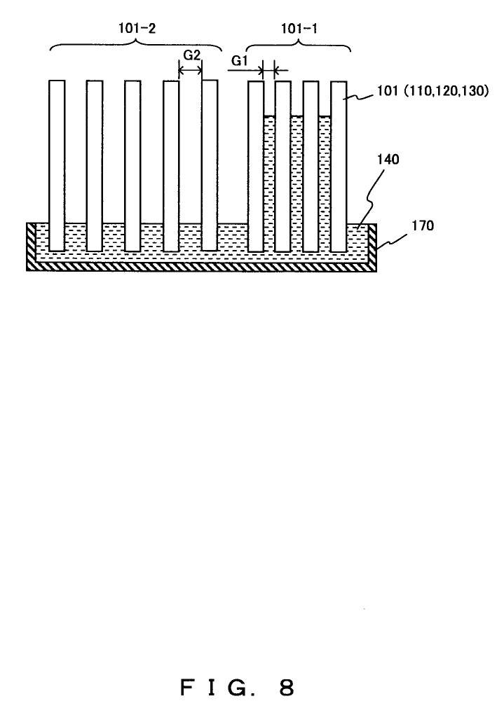

Furthermore, as illustrated in FIG. 8, when a plurality of liquid crystal panels 101 (before injecting the liquid crystal material 140) provided with the first substrate 110 and the second substrate 120 are to be inserted into the liquid crystal material 140 in the liquid crystal vessel 170, and if the intervals between the liquid crystal panels 101 are short (interval G1) as the liquid crystal panels 101-1 on the right in FIG. 8, the surface tension forces the liquid crystal material 140 to enter the gap between the liquid crystal panels 101.

On the other hand, if the intervals between the liquid crystal panels 101 are long as the liquid crystal panels 101-2 on the left in FIG. 8 (gap G2) , the quantity of the liquid crystal material 140 stored in the liquid crystal vessel 170 increases for the gap.

To keep the intervals between the liquid crystal panels 101 as described above, the excess amount of liquid crystal material 140 is necessary. However, to maintain a liquid crystal inlet 101a of the liquid crystal panel 101 in the liquid crystal material 140 when the liquid crystal material 140 is injected, there is a method for inserting the liquid crystal inlet 101a into the liquid crystal vessel 170 by filling the liquid crystal vessel 170 with an excess of liquid crystal material 140.

Concretely, when the liquid crystal inlet 101a reaches the flat bottom of the liquid crystal vessel 170, the liquid crystal inlet 101a is blocked. Therefore, the liquid crystal panel 101 is held by the jig as lifted at least by the minimum gap (G3) between the liquid crystal panel 101 and the bottom of the liquid crystal vessel 170.

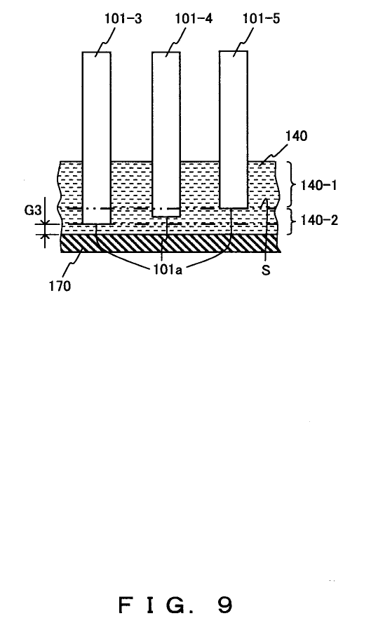

However, depending on the production accuracy of the liquid crystal panel 101 and the position accuracy of a jig, the height of the liquid crystal inlet 101a is not constant for the liquid crystal panel 101-4 at the center or the liquid crystal panel 101-5 on the right as illustrated in FIG. 9.

Therefore, the level of the liquid crystal inlet 101a (the level of the right liquid crystal panel 101-5 in FIG. 9) at the highest of all (farthest from the bottom of the liquid crystal vessel 170) is set as the lowest liquid surface level S. Since the liquid crystal material 140 is to be stored up to the level higher than the lowest liquid surface level S, the liquid crystal material 140-1 above the lowest liquid surface level S is stored in the liquid crystal panel 101, but the liquid crystal material 140-2 below the lowest liquid surface level S is stored in excess of the necessary quantity.

Generally, when the quantity of the liquid crystal material 140 stored in the liquid crystal vessel 170 increases, the time period in which the liquid crystal material 140 is exposed to air becomes longer and the material is contaminated (absorbs water), and is not available, thereby causing the problem of wasteful liquid crystal materials.

The method and the device for injecting the liquid crystal for a film substrate according to the embodiment of the present invention are described below with reference to the attached drawings.

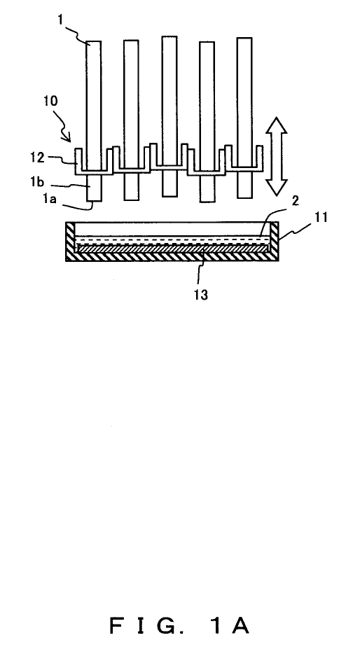

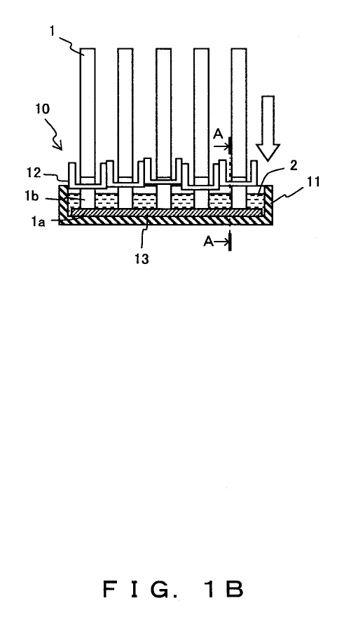

FIGS. 1A and 1B are partial sectional views of the liquid crystal injection device 10 according to an embodiment of the present invention.

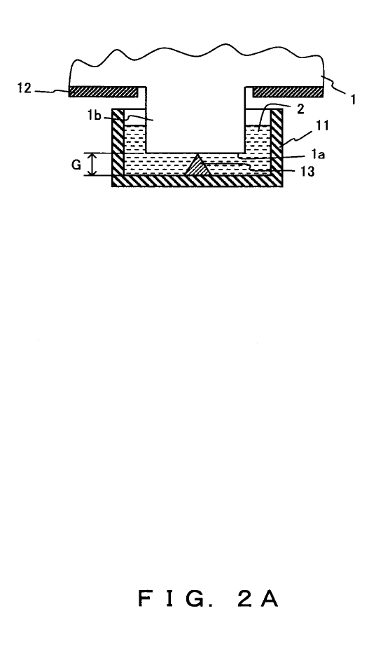

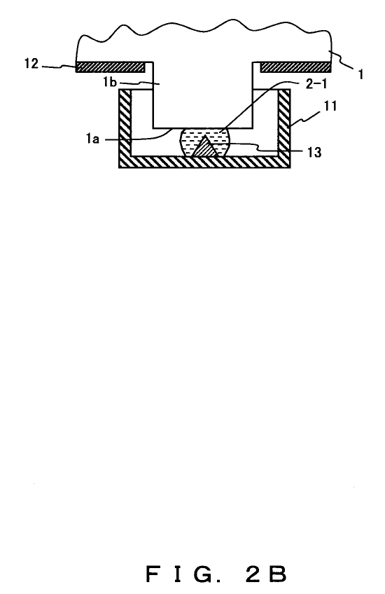

FIGS. 2A and 2B are sectional views along A-A in FIG. 1B.

A liquid crystal injection device 10 illustrated in FIGS. 1A and 1B includes a liquid crystal vessel 11 which stores a liquid crystal material 2, and a jig 12 which supports a film substrate 1 at least upward perpendicularly. The liquid crystal injection device 10 injects the liquid crystal material 2 into the film substrate 1 as, for example, a liquid crystal panel.

The film substrate 1 is formed by bonding two substrates each of which is made of a flexible film. At least one of these two substrates is transparent is transparent and the transparent electrodes not illustrated in the attached drawings are bonded as facing each other. The film substrate 1 is rectangular, and a projection 1b which protrudes as a rectangle is formed on one of the four sides of the rectangle. The end of the projection 1b is a liquid crystal inlet 1a into which the liquid crystal material 2 is injected.

The liquid crystal vessel 11 has a convex part 13 as an example of the contact part. The convex part 13 forms a gap G illustrated in FIG. 2A between the liquid crystal inlet 1a of the film substrate 1 and the bottom of the liquid crystal vessel 11 by contacting the film substrate 1.

The convex part 13 protrudes upward from the bottom of the liquid crystal vessel 11 and has a longitudinal direction in the array direction. Concretely, the convex part 13 is formed so that a triangular pole member may lie in the array direction of the film substrate 1 with one of the three rectangular planes contacting the bottom of the liquid crystal vessel 11, thereby providing a triangular section.

The convex part 13 linearly contacts a part of a liquid crystal inlet 11a of the film substrate 1 at the upper end linearly extruded in the longitudinal direction. The convex. part 13 may be provided as a unitary construction with the liquid crystal vessel 11, or provided by arranging another member in the liquid crystal vessel 11.

The jig 12 is arranged for each film substrate 1, and a plurality of jigs 12 independently rise and fall. The jig 12 supports the film substrate 1 upward perpendicularly on both sides of the bottom with the projections 1b of the film substrate 1 interposed between them. The jig 12 may prevent the film substrate 1 from tilting by, for example, supporting the projection 1b of the film substrate 1, horizontally supporting the film substrate 1 in the direction of thickness on both sides with the projection 1b interposed, etc.

The method for injecting the liquid crystal according to an embodiment of the present invention is described below with some points overlapping the description above appropriately omitted.

First, as illustrated in FIG. 1A, a plurality of film substrates 1 are supported by a plurality of jigs 12, which independently rise and fall, above the liquid crystal vessel 11 for storing the liquid crystal material 2. In this case, the height of the liquid crystal inlet 1a fluctuates for each film substrate 1 depending on the production accuracy of the film substrate 1 and the position accuracy of the jig 12.

Next, as illustrated in FIG. 1B, the liquid crystal inlet 1a of the film substrate 1 contacts the convex part 13 provided in the liquid crystal vessel 11 by the fall of the jig 12. Thus, as illustrated in FIG. 2A, the gap G is formed at equal intervals between the liquid crystal inlet 1a and the bottom of the liquid crystal vessel 11 (contacting step).

Then, by the fall of the jig 12 even after the contact of the film substrate 1 with the convex part 13, the perpendicularly upward support of the jig 12 on the film substrate 1 is released, and the positions of the liquid crystal inlets 1a of the plurality of film substrates 1 match on the convex part 13. By the horizontal support of the jig 12 on the film substrate 1, the film substrate 1 may be positioned although the perpendicularly upward support is released.

Next, the liquid crystal material 2 is injected through the liquid crystal inlet 1a from the gap G with the film substrate 1 in contact with the convex part 13 (injecting step).

The film substrate 1 is stored in, for example, a housing not illustrated in the attached drawings, the housing is kept in the decompressed state, the liquid crystal inlet 1a is inserted into the liquid crystal material 2 in the decompressed state in the contacting step, and then the liquid crystal material 2 is injected from the liquid crystal inlet 1a by changing the decompressed state in the housing not illustrated in the attached drawings into the normal pressure state.

As illustrated in FIG. 2B, in the injecting step, the liquid crystal material 2 is gathered around the convex part 13 by the surface tension even with the level of the liquid of the liquid crystal material 2 in the liquid crystal vessel 11 lower than the convex part 13, and the gathered liquid crystal turns into a liquid pool 2-1, and contacts the liquid crystal inlet 1a, thereby injecting the liquid crystal into the film substrate 1.

The liquid crystal vessel 11 according to the present embodiment is made of, for example, aluminum, and it is designed so that the liquid pool 2-1 may be easily formed on the convex part 13 by forming a fluorine coating part (an example of a coating part) for preventing the invasion of the liquid crystal material 2.

After the injection of the liquid crystal material 2, the sealing material for sealing the liquid crystal material 2 is injected through the liquid crystal inlet 1a and cured by ultraviolet rays etc., thereby completing the seal of the liquid crystal material 2 on the film substrate 1.

According to the present embodiment described above, the gap is formed between the liquid crystal inlet 1a of the film substrate 1 and the bottom of the liquid crystal vessel 11 by the film substrate 1 contacting the convex part 13 provided for the liquid crystal vessel 11 for storing the liquid crystal material 2 (contacting step). In addition, the liquid crystal material 2 is injected through the liquid crystal inlet 1a from the gap G with the film substrate 1 contacting the convex part 13 (injecting step).

Therefore, the liquid crystal inlet 1a of the film substrate 1 may be prevented from being blocked by the bottom of the liquid crystal vessel 11. In addition, the liquid crystal material 2 may be prevented from being excessively stored in the liquid crystal vessel 11 depending on the variance of the level of the film substrate 1 by forming the convex part 13 with the smallest possible number of gaps G for injection of the liquid crystal material 2.

Therefore, according to the present embodiment, the quantity of the liquid crystal material 2 stored in the liquid crystal vessel 11 may be reduced.

According to the present embodiment, the convex part 13 as an example of the contact part which contacts the film substrate 1 is provided for the liquid crystal vessel 11. Therefore, the quantity of the liquid crystal material 2 stored in the liquid crystal vessel 11 may be reduced with a simple configuration.

According to the present embodiment, the convex part 13 linearly contacts the liquid crystal inlet 1a of the film substrate 1. Therefore, the gap G between the liquid crystal inlet 1a and the bottom of the liquid crystal vessel 11 may be constantly made regardless of the production accuracy of the film substrate 1, thereby further reducing the quantity of the liquid crystal material 2 to be stored in the liquid crystal vessel 11.

In addition, in the injecting step according to the present embodiment, the liquid pool 2-1 of the liquid crystal material 2 formed in the convex part 13 by the surface tension is injected through the liquid crystal inlet 1a with the liquid level of the liquid crystal material 2 in the liquid crystal vessel 11 lower than the liquid crystal material 2. Therefore, although the liquid level of the liquid crystal material 2 is lower than the gap G between the liquid crystal inlet 1a and the bottom of the liquid crystal vessel 11, the liquid crystal material 2 may be injected, thereby further reducing the quantity of the liquid crystal material 2 stored in the liquid crystal vessel 11.

In the contacting step according to the present embodiment, the film substrate 1 is made to contact the convex part 13 by lowering the jig 12 which supports at least upward perpendicularly, and the perpendicularly upward support of the jig 12 on the film substrate 1 is released by lowering the jig 12 even after the contact of the film substrate 1 with the convex part 13. Therefore, the variance of the level of the film substrate 1 may be suppressed without fail, and the quantity of the film substrate 1 stored in the liquid crystal vessel 11 may be further reduced.

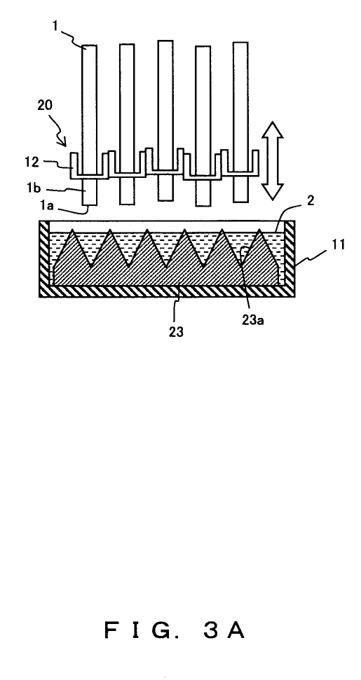

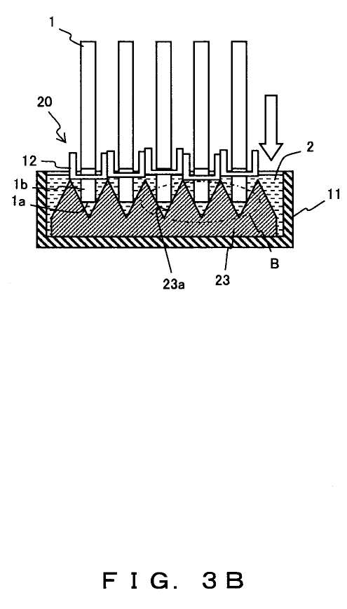

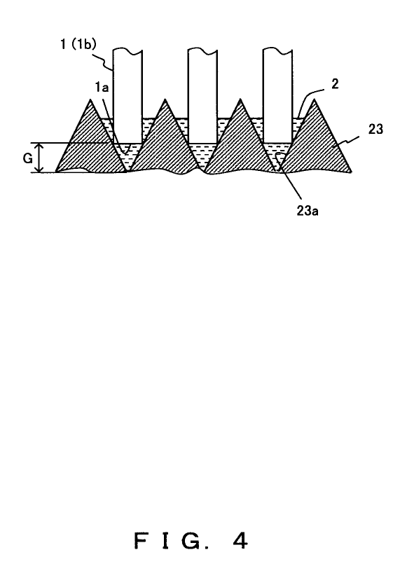

FIGS. 3A and 3B are partial sectional views of the liquid crystal injection device according to another embodiment of the present invention. FIG. 4 is an enlarged view of the part B in FIG. 3B.

According to the present embodiment, as an example of the contact part, not the convex part 13, but a concave part 23a of a projection 23 is provided, which is different from the embodiment described above. Otherwise, the present embodiment is generally the same as the embodiment described above. The difference is mainly described below.

The liquid crystal injection device 20 illustrated in FIGS. 3A and 3B includes the liquid crystal vessel 11 which stores the liquid crystal material 2, and the jig 12 which supports the film substrate 1 at least upward and perpendicularly, and injects the liquid crystal material 2 into the film substrate 1 which is, for example, a liquid crystal panel.

The liquid crystal vessel 11 has the concave part 23a as an example of the contact part formed in the concave part 23a. The concave part 23a forms the gap G illustrated in FIG. 4 between the liquid crystal inlet 1a of the film substrate 1 and the bottom of the liquid crystal vessel 11 by contacting the film substrate 1.

The projection 23 protrudes upward from the bottom of the liquid crystal vessel 11. The concave part 23a is a groove having the longitudinal direction and extending in the direction (longitudinal direction of the liquid crystal inlet 1a) orthogonal to the array direction of the film substrate 1. Concretely, the concave part 23a is a groove having a V-shaped section which linearly contacts the periphery (2 opposite sides) of the inlet where the liquid crystal inlet 1a of the film substrate 1 is formed as illustrated in FIG. 4.

The projection 23 may have a unitary construction with the liquid crystal vessel 11 or may be provided by arranging another member for the liquid crystal vessel 11.

Described below is the liquid crystal injecting method according to another embodiment by appropriately omitting some overlapping points described above.

First, as illustrated in FIG. 3A, the film substrates 1 are supported by a plurality of jigs 12 which independently rise and fall above the liquid crystal vessel 11 which stores the liquid crystal material 2. In this case, the level of the liquid crystal inlet 1a fluctuates for each film substrate 1 depending on the production accuracy of the film substrate 1 and the position accuracy of the jig 12.

Next, as illustrated in FIG. 3B, when the jig 12 falls, the liquid crystal inlet 1a of the film substrate 1 linearly contacts the two planes which form a V shape of the concave part 23a of the projection 23 provided for the liquid crystal vessel 11. Thus, a gap G is formed between the liquid crystal inlet 1a and the bottom (the bottom of the concave part 23a in the present embodiment) of the liquid crystal vessel 11 (contacting step).

Then, even after the film substrate 1 contacts the concave part 23a, the fall of the jig 12 releases the perpendicularly upward support of the jig 12 on the film substrate 1, and the positions of the liquid crystal inlets 1a of the plurality of film substrates 1 match the contact positions of the concave parts 23a. By the jig 12 horizontally supporting the film substrate 1, the film substrate 1 may be positioned even after the release of the perpendicularly upward support.

Next, the liquid crystal material 2 is injected through the liquid crystal inlet 1a from the gap G described above with the film substrate 1 contacting the concave part 23a (injecting step) .

After the injection of the liquid crystal material 2 is completed, the sealing material for sealing the liquid crystal material 2 is injected through the liquid crystal inlet 1a and cured by ultraviolet rays etc., thereby completing the seal of the liquid crystal material 2 on the film substrate 1.

According to the present embodiment described above, the gap G is formed between the liquid crystal inlet 1a of the film substrate 1 and the bottom of the liquid crystal vessel 11 by the film substrate 1 contacting the concave part (contact part) 23a provided for the liquid crystal vessel 11 which stores the liquid crystal material 2 (contacting step). Furthermore, in the contact state between the film substrate 1 and the concave part 23a, the liquid crystal material 2 is injected from the gap G through the liquid crystal inlet 1a (injecting step).

Therefore, according to the present embodiment, as with the embodiment described above, the quantity of the liquid crystal material 2 stored in the liquid crystal vessel 11 may be reduced.

According to the present embodiment, as an example of a contact part which the film substrate 1 contacts, the concave part 23a of the projection 23 is provided for the liquid crystal vessel 11. Therefore, the liquid crystal material 2 may be collected in the concave part 23a and the quantity of the liquid crystal material 2 may be reduced with a simple configuration. Furthermore, since the liquid crystal material 2 different for each concave part 23a may be stored, the liquid crystal material 2 may be injected simultaneously into different types of film substrates 1.

Furthermore, according to the present embodiment, the concave part 23a contacts the periphery (two opposite sides) of the inlet forming sides which form the liquid crystal inlet 1a of the film substrate 1. Therefore, since the gap G between the liquid crystal inlet 1a and the bottom (the bottom of the concave part 23a) of the liquid crystal vessel 11 may be regulated independent of the production accuracy of the jig 12 and the film substrate 1, the liquid crystal may be injected at the shortest possible intervals the quantity of the liquid crystal material 2 stored in the liquid crystal vessel 11 may be furthermore reduced.

Furthermore, according to the present embodiment, the concave part 23a is a groove which extends in the longitudinal direction of the liquid crystal inlet 1a. Therefore, the gap G between the liquid crystal inlet 1a and the bottom (the bottom of the concave part 23a) of the liquid crystal vessel 11 may be maintained without fail by the concave part 23a contacting the liquid crystal inlet 1a in the longitudinal direction of the liquid crystal inlet 1a, thereby further reducing the quantity of the liquid crystal material 2 stored in the liquid crystal vessel 11.

According to the present embodiment, the concave part 23a is a groove having a V-shaped section. Therefore, the gap G between the liquid crystal inlet 1a and the bottom (the bottom of the concave part 23a) of the liquid crystal vessel 11 may be constant by the concave part 23a contacting the film substrate 1 on the two V-shaped planes, thereby furthermore reducing the quantity of the liquid crystal material 2 stored in the liquid crystal vessel 11.

In addition, in the contacting step according to the present embodiment, the film substrate 1 is made to contact the concave part 23a by lowering the jig 12 which supports the film substrate 1 at least perpendicularly upward, and the jig 12 is made to lower even after the film substrate 1 contacts the concave part 23a, thereby releasing the perpendicularly upward support of the jig 12 on the film substrate 1. Accordingly, the variance of the height of the film substrate 1 may be suppressed without fail, and the quantity of the liquid crystal material 2 stored in the liquid crystal vessel 11 may be furthermore reduced.

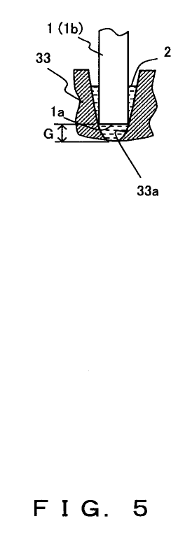

According to the present embodiment, the concave part 23a which is a groove having a V-shaped section formed on the projection 23 as illustrated in FIG. 4 is explained as an example of the contact part, but the contact part may be a concave part 33a as a U-shaped groove formed on a projection 33 as a variation example illustrated in FIG. 5 or any other concave parts to reduce the quantity of the liquid crystal material 2 stored in the liquid crystal vessel 11.

In addition, in the above-mentioned embodiment and another embodiment, the convex part 13, the concave parts 23a and 33a, etc. are examples of the contact part, but the contact part may be two or more convex or concave parts for each film substrate 1 such as convex and concave surfaces of a rough surface etc.

Although the attached drawings illustrate the hatching indicating a section in a drawing, but the types of hatching do not restrict the material.

What is claimed is:

1. A method for injecting a liquid crystal material into a film substrate, comprising:
forming a gap between a liquid crystal inlet of the film substrate and a bottom of a liquid crystal vessel which stores the liquid crystal material by making the film substrate contact a contact part provided for the liquid crystal vessel; and
injecting the liquid crystal material into the liquid crystal inlet with the film substrate contacting the contact part.

2. The method according to claim 1, wherein
the contact part is a convex part.

3. The method according to claim 2, wherein
the convex part linearly contacts the liquid crystal inlet of the film substrate.

4. The method according to claim 3, wherein
in the injecting of the liquid crystal material, a liquid pool of the liquid crystal material formed on the convex part by surface tension is injected through the liquid crystal inlet in the state in which the level of the liquid of the liquid crystal material in the liquid crystal vessel is lower than the convex part.

5. The method according to claim 1, wherein
the contact part is a concave part into which the liquid crystal inlet is inserted.

6. The method according to claim 5, wherein
the concave part contacts the periphery of the inlet formed as the liquid crystal inlet of the film substrate.

7. The method according to claim 5, wherein
the concave part is a groove which extends in a longitudinal direction of the liquid crystal inlet.

8. The method according to claim 5, wherein
the concave part is a groove having a V-shaped section.

9. The method according to claim 5, wherein
the concave part is a groove having a U-shaped section.

10. The method according to claim 1, wherein
in the forming of the gap, the film substrate is made to contact the contact part by lowering the jig which supports the film substrate at least perpendicularly upward, and the jig is lowered even after the film substrate contacts the contact part, thereby releasing the perpendicularly upward support of the jig on the film substrate.

11. A liquid crystal injection device which injects a liquid crystal material into a film substrate, comprising:
a liquid crystal vessel which stores the liquid crystal material, wherein
the liquid crystal vessel includes a contact part which forms a gap between a liquid crystal inlet of the film substrate and a bottom of the liquid crystal vessel by making the liquid crystal vessel contact the film substrate.

12. The device according to claim 11, further comprising
a jig which supports the film substrate at least perpendicularly upward, wherein
the jig is lowered to make the film substrate contact the contact part, and is further lowered even after the film substrate contacts the contact part to release the perpendicularly upward support on the film substrate.
